(19) United States
(12) Patent Application Publication
(10) Pub. No.: US 2007/0038482 A1
(43) Pub. Date: Feb. 15, 2007

(54) Cosmetic dental insurance policy

(75) Inventors: Wendy Lynn Herndon, Columbus, GA (US); Jo Ann King, Columbus, GA (US); Thomas Owen Morey, Columbus, GA (US); Donna Lea Auten, Fortson, GA (US); Deborah Thomas Grantham, Woodland, GA (US); Katherine Lowry Gant, Columbus, GA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: AFLAC

(21) Appl. No.: 11/201,628

(22) Filed: Aug. 10, 2005

(51) Int. Cl. G06Q 40/00

(52) U.S. Cl. 705/4

(57) ABSTRACT

A cosmetic dental insurance policy and a system and method for issuing a cosmetic dental insurance policy providing cosmetic dental benefits are provided. In one embodiment, the cosmetic dental insurance policy is a rider to a base dental insurance policy. Cosmetic dental benefits include, for example, veneers and bleaching. A system for processing a claim received from a cosmetic dental insurance policyholder is also provided.

### BACKGROUND OF THE INVENTION

1. Field of the Invention

The present invention generally relates to insurance policies, and particularly relates to dental insurance policies, specifically a cosmetic rider policy for a base dental insurance policy.

2. Description of Related Art

Current base dental insurance policies typically provide policyholders with basic preventative and restorative examinations and treatments, such as annual check-ups and cleanings, x-rays and fillings, at a reduced cost or in some cases without additional cost to the policyholder. However, there is a need for improved dental insurance policies that provide additional types of dental-related coverage.

### BRIEF SUMMARY OF THE INVENTION

Generally described, various embodiments of the present invention provide an improvement over the known prior art by providing a cosmetic dental insurance policy or a rider to a base dental insurance policy and a method, system, computing device, and policy for issuing the policy or rider. The rider provides policyholders with cosmetic-related dental coverage that is in addition to base dental insurance coverage for check-ups, cleanings and restorative products. A system for processing a claim received from a cosmetic dental insurance policyholder is also provided.

According to one aspect of the present invention, a system for issuing a cosmetic dental insurance policy is provided. The system is comprised of a processor and a memory coupled to the processor that stores an application executable by the processor. The application receives applicant data related to a prospective policy participant. It then applies one or more business rules stored in the memory to the applicant data to determine whether the prospective policy participant qualifies for cosmetic dental insurance policy. The application then transmits the cosmetic dental insurance policy to a policy participant, where the policy participant is comprised of the prospective policy participant determined to qualify for then cosmetic dental insurance policy. The cosmetic dental insurance policy provides a cosmetic dental benefit that provides a payment to a provider or the policy participant of a portion or all of a covered cosmetic dental procedure.

Another aspect of the invention is a system for processing a cosmetic dental insurance policy claim. The system is comprised of a processor and a memory connected to the processor that stores a computer program executed by the processor. The computer program receives a cosmetic dental insurance policy claim from a policy participant, wherein the policy participant is a policyholder of a cosmetic dental insurance policy. The computer program determines whether the policy participant incurred one or more expenses related to covered cosmetic dental procedures. If so, then the computer program authorizes provision of some combination of a cosmetic dental benefit.

Another aspect of the present invention is a cosmetic dental insurance policy. The policy provides a cosmetic dental benefit that provides for one or more cosmetic dental benefit payments to be made in response to a policy participant receiving covered cosmetic dental procedures from a provider.

Yet another aspect of the,present invention is a method of issuing a cosmetic dental insurance policy. The method is comprised of the steps of receiving applicant data related to a prospective policy participant, and determining, based at least in part on the applicant data, whether the prospective policy participant qualifies for the cosmetic dental insurance policy. If the prospective policy participant does qualify, then issuing the cosmetic dental insurance policy to the policy participant. The cosmetic dental insurance policy comprises a cosmetic dental benefit that provides a payment to a provider or the policy participant of a portion or all of a covered cosmetic dental procedure.

Another aspect of the present invention is a method of processing a cosmetic dental insurance policy claim. The method is comprised of the steps of receiving a cosmetic dental insurance policy claim from a policy participant and determining whether the policy participant incurred one or more expenses related to a covered cosmetic dental procedure. If so, then providing a cosmetic dental benefit associated with the covered cosmetic dental procedure.

Yet another aspect of the present invention is a method of offering a cosmetic dental insurance policy. The method is comprised of the steps of providing a cosmetic dental insurance application to an applicant, wherein the cosmetic dental insurance policy provides a cosmetic dental benefit comprised of a payment to a policy participant or a provider for covered cosmetic dental procedures. Then, receiving applicant information from the applicant and determining whether the applicant is qualified to become one of the policy participants. If the applicant is authorized to become one of the policy participants, then issuing the cosmetic dental insurance policy to the applicant, the applicant thus becomes a policy participant.

These and other aspects of the present invention are more fully described herein.

### BRIEF DESCRIPTION OF THE DRAWING(S)

Having thus described the invention in general terms, reference will now be made to the accompanying drawings, which are not necessarily drawn to scale, and wherein:

FIG. 1a is an illustration of one embodiment of a computer that can be used to practice aspects of the present invention;

FIG. 1b is an embodiment of a processing system having a distributed communication and processing architecture that may be used to practice aspects of the present invention;

FIG. 2 is an illustration of an exemplary cosmetic dental insurance rider that may be used to practice aspects of the invention;

FIG. 3 is a block diagram of a system for issuing a cosmetic dental insurance policy according to one embodiment of the present invention;

FIG. 4 is a block diagram of an Insurance Company computer in accordance with one embodiment of the present invention;

FIG. 5 is a block diagram of a Computing Device in accordance with one embodiment of the present invention;

FIG. 6A is a flow chart illustrating a method of issuing a cosmetic dental insurance policy according to an embodiment of the present invention;

FIG. 6B is a flow chart illustrating a method of issuing a cosmetic dental insurance policy or according to another embodiment of the present invention;

FIG. 7 is a block diagram of a system for processing a cosmetic dental insurance policy claim according to one embodiment of the present invention;

FIG. 8 is a block diagram of a Claim Processing Server in accordance with embodiments of the present invention; and

FIG. 9 is a flow chart illustrating a method of processing a cosmetic dental insurance policy claim according to an embodiment of the present invention.

### DETAILED DESCRIPTION OF THE INVENTION

The present invention now will be described more fully with reference to the accompanying drawings, in which some, but not all embodiments of the invention are shown. Indeed, this invention may be embodied in many different forms and should not be construed as limited to the embodiments set forth herein. Rather, these embodiments are provided so that this disclosure will satisfy applicable legal requirements. Like numbers refer to like elements throughout.

As will be appreciated by one skilled in the art, the present invention may be embodied as a method, a data processing system, or a computer program product. Accordingly, the present invention may take the form of an entirely hardware embodiment, an entirely software embodiment, or an embodiment combining software and hardware aspects. Furthermore, the present invention may take the form of a computer program product on a computer-readable storage medium having computer-readable program instructions (e.g., computer software) embodied in the storage medium. More particularly, the present invention may take the form of web-implemented computer software. Any suitable computer-readable storage medium may be utilized including hard disks, CD-ROMs, optical storage devices, or magnetic storage devices.

The present invention is described below with reference to block diagrams and flowchart illustrations of methods, apparatuses (i.e., systems) and computer program products according to an embodiment of the invention. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

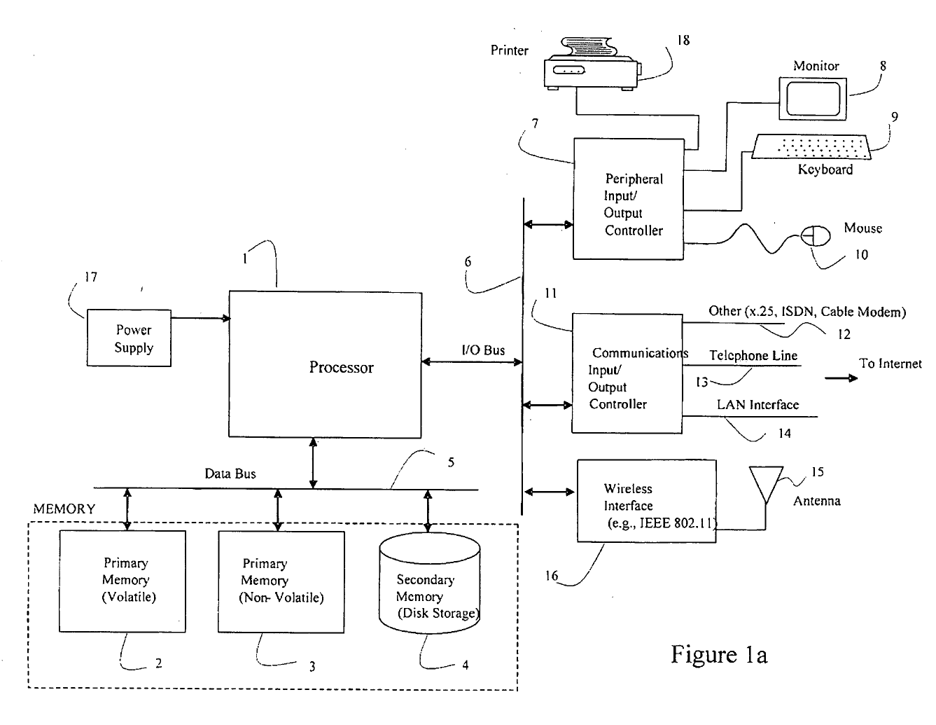

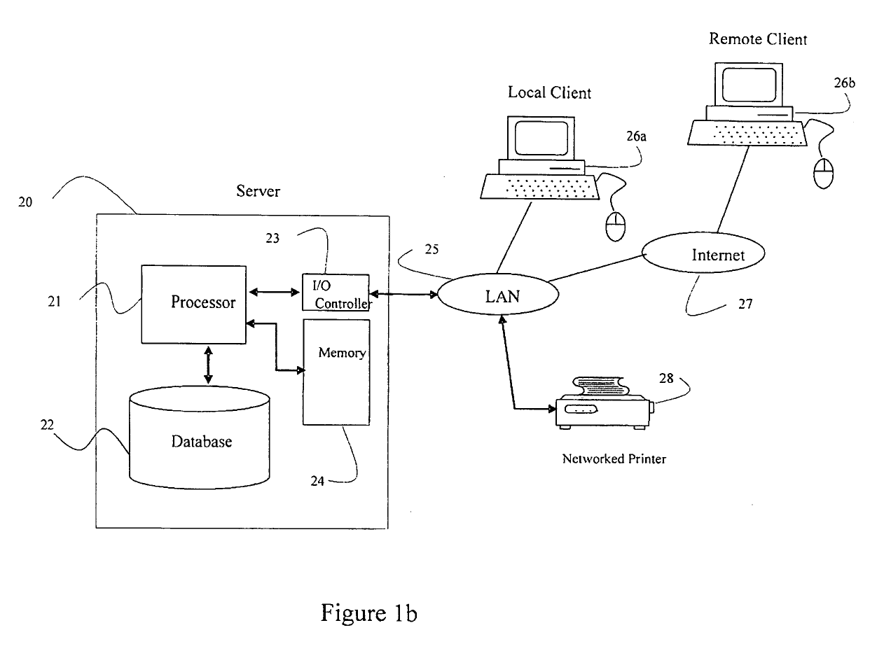

In several of the embodiments of the invention referenced herein, a “computer” is referenced. The computer may be, for example, a mainframe, desktop, notebook or laptop, or a hand held device such as a data acquisition and storage device, etc. In some instances the computer may be a “dumb” terminal used to access data or processors over a network. Turning to FIG. 1a, one embodiment of a computer is illustrated that can be used to practice aspects of the present invention. In FIG. 1a, a processor 1, such as a microprocessor, is used to execute software instructions for carrying out the defined steps. The processor receives power from a power supply 17 that also provides power to the other components as necessary. The processor 1 communicates using a data bus 5 that is typically 16 or 32 bits wide (e.g., in parallel). The data bus 5 is used to convey data and program instructions, typically, between the processor and memory. In the present embodiment, memory can be considered primary memory 2 that is RAM or other forms which retain the contents only during operation, or it may be non-volatile 3, such as ROM, EPROM, EEPROM, FLASH, or other types of memory that retain the memory contents at all times. The memory could also be secondary memory 4, such as disk storage, that stores large amount of data. In some embodiments, the disk storage may communicate with the processor using an I/O bus 6 instead or a dedicated bus (not shown). The secondary memory may be a floppy disk, hard disk, compact disk, DVD, or any other type of mass storage type known to those skilled in the computer arts.

The processor 1 also communicates with various peripherals or external devices using an I/O bus 6. In the present embodiment, a peripheral I/O controller 7 is used to provide standard interfaces, such as RS-232, RS422, DIN, USB, or other interfaces as appropriate to interface various input/output devices. Typical input/output devices include local printers 18, a monitor 8, a keyboard 9, and a mouse 10 or other typical pointing devices (e.g., rollerball, trackpad, joystick, etc.).

The processor 1 typically also communicates using a communications I/O controller 11 with external communication networks, and may use a variety of interfaces such as data communication oriented protocols 12 such as X.25, ISDN, DSL, cable modems, etc. The communications controller 11 may also incorporate a modem (not shown) for interfacing and communicating with a standard telephone line 13. Finally, the communications I/O controller may incorporate an Ethernet interface 14 for communicating over a LAN. Any of these interfaces may be used to access the Internet, intranets, LANs, or other data communication facilities.

Finally, the processor 1 may communicate with a wireless interface 16 that is operatively connected to an antenna 15 for communicating wirelessly with another device, using for example, one of the IEEE 802.11 protocols, 802.15.4 protocol, or a standard 3G wireless telecommunications protocols, such as CDMA2000 1×EV-DO, GPRS, W-CDMA, or other protocol.

An alternative embodiment of a processing system that may be used is shown in FIG. 1b. In this embodiment, a distributed communication and processing architecture is shown involving a server 20 communicating with either a local client computer 26a or a remote client computer 26b. The server 20 typically comprises a processor 21 that communicates with a database 22, which can be viewed as a form of secondary memory, as well as primary memory 24. The processor also communicates with external devices using an I/O controller 23 that typically interfaces with a LAN 25. The LAN may provide local connectivity to a networked printer 28 and the local client computer 26a. These may be located in the same facility as the server, though not necessarily in the same room. Communication with remote devices typically is accomplished by routing data from the LAN 25 over a communications facility to the Internet 27. A remote client computer 26b may execute a web browser, so that the remote client 26b may interact with the server as required by transmitted data through the Internet 27, over the LAN 25, and to the server 20.

Those skilled in the art of data networking will realize that many other alternatives and architectures are possible such as, for example, the handheld devices contemplated herein and can be used to practice the principles of the present invention. The embodiments illustrated in FIGS. 1a and 1b can be modified in different ways and be within the scope of the present invention as claimed.

Cosmetic Dental Insurance Policy

A cosmetic dental insurance policy (also referred to as a “cosmetic policy” or a “cosmetic dental policy”) according to one embodiment of the invention comprises cosmetic dental benefits that provide a payment to a provider or a policyholder of a portion or all of a covered cosmetic dental procedure. In one embodiment, the cosmetic dental insurance policy is provided as a rider to a base dental insurance policy. Exemplary base dental insurance benefits and cosmetic dental benefits are described more fully below.

Base Dental Insurance Benefits

In various embodiments of the invention, base dental insurance may provide benefits that include, for example, dental wellness benefits, x-ray benefits, preventative benefits, diagnostic benefits, fillings and other restorative benefits, crowns and other major restorative benefits, root canals and other endodontic benefits, gum treatments/periodontic benefits, dentures and other prosthetic benefits, repairs and adjustments to prosthetic benefits, extractions and other oral surgery benefits, and pain relief and adjunctive services benefits. Benefits are generally described in a dental insurance policy's “Policy Schedule.” An exemplary Policy Schedule's benefit categories are shown below in Table I, and the Policy Schedule's optional benefits are shown in Table II. Benefits may, or may not, be subject to a waiting period before they are fully effective and the waiting periods shown in Tables I and II are for exemplary purposes only.

TABLE I

| Benefit Categories | Waiting Periods |
|---|---|
| Dental Wellness Benefits | [0, 0 months] |
| X-Ray Benefit | [0, 0 months] |
| Other Preventive Benefits | [0, 6 months] |
| Other Diagnostic Benefits | [0, 3 months] |
| Fillings and Other Basic Restorative Benefits | [0, 3 months] |
| Crowns and Other Major Restorative Benefits | [3, 12 months] |
| Root Canals and Other Endodontic Benefits | [3, 12 months] |
| Gum Treatments/Periodontic Benefits | [3, 6 months] |
| Dentures and Other Prosthetic Benefits | [6, 24 months] |
| Repairs and Adjustments to Prosthetic Benefits | [3, 6 months] |
| Extractions and Other Oral Surgery Benefits | [3, 6 months] |
| Pain Relief and Adjunctive Services Benefits | [3, 3 months] |

TABLE II

| Optional Benefits | Waiting Periods |
|---|---|
| Orthodontic Benefit Rider | 24 months |
| Cosmetic Benefit Rider | 24 months |

Dental wellness benefits provide, for example, a predetermined payment to be made when a charge is incurred for an oral evaluation, prophylaxis, fluoride treatment, counseling, etc. for a person covered by the base dental insurance policy (a “policy participant”). In various embodiments, this payment may be made directly to the policy participant or to a service provider. In embodiments of the invention, the base dental insurance policy may provide for policy participants to receive one or more wellness benefits at no cost, or substantially no cost, to the policy participant on an annual basis.

X-ray benefits provide, for example, for a predetermined x-ray payment to be made when a policy participant receives one or more dental related x-rays such as, for example, interoral, extraoral, bitewing, vertical bitewing, panoramic film, or cephalometric film x-rays. The x-ray benefit payment may be made, for example, directly to the policy participant or to a service provider. In embodiments of the invention, the base dental policy may provide for policy participants to receive the x-ray benefit at no cost, substantially no cost or at a fixed or defined benefit amount, and such benefits may be limited based on a time period (e.g., once per year, twice per year, etc.)

Other preventive benefits include sealants, space maintainers, and recementation of space maintainers. The benefit payments may be made, for example, directly to the policy participant or to a service provider. In embodiments of the invention, the base dental policy may provide for policy participants to receive the other preventative benefits at no cost, substantially no cost or at a fixed or defined benefit amount, and such benefits may be limited based on a time period (e.g., once per year, twice per year, etc.)

Other diagnostic benefits include oral evaluations, skull and facial bone survey film, sialography, bacteriological studies, pulp vitality tests, diagnostic casts and photographs, and histopathological exams. The benefit payments may be made, for example, directly to the policy participant or to a service provider. In embodiments of the invention, the base dental policy may provide for policy participants to receive the other diagnostic benefits at no cost, substantially no cost or at a fixed or defined benefit amount, and such benefits may be limited based on a time period (e.g., once per year, twice per year, etc.)

Fillings and other basic restorative benefits include amalgams, resin-based composites including resin-based composite crowns, and gold foil. The benefit payments may be made, for example, directly to the policy participant or to a service provider. In embodiments of the invention, the base dental policy may provide for policy participants to receive the fillings and other basic restorative benefits at no cost, substantially no cost or at a fixed or defined benefit amount, and such benefits may be limited based on a time period (e.g., once per year, twice per year, etc.)

Crowns and other major restorative benefits include inlays, onlays, crown repairs, sedative fillings, core buildup, pin retention, cast or prefabricated post and core, post removal and temporary crowns. The benefit payments may be made, for example, directly to the policy participant or to a service provider. In embodiments of the invention, the base dental policy may provide for policy participants to receive the crowns and other major restorative benefits at no cost, substantially no cost or at a fixed or defined benefit amount, and such benefits may be limited based on a time period (e.g., once per year, twice per year, etc.)

Root canals and other endodontic benefits include pulp caps, pulpal therapy and therapeutic pulpotomy, root canals and treatment, apexification/recalcification, apicoectomy/periradicular surgery, retrograde fillings, root amputations, hemisections and canal preparation. The benefit payments may be made, for example, directly to the policy participant or to a service provider. In embodiments of the invention, the base dental policy may provide for policy participants to receive the root canals and other endodontic benefits at no cost, substantially no cost or at a fixed or defined benefit amount, and such benefits may be limited based on a time period (e.g., once per year, twice per year, etc.)

Gum treatments/periodontic benefits include gingivectomies or gingivoplasties, gingival flap procedures, clinical crown lengthening, mucogingivla surgery, osseous surgery. Bone replacement grafts, soft tissue grafts, provisional splintings, scaling and root planning, and mouth debridement. The benefit payments may be made, for example, directly to the policy participant or to a service provider. In embodiments of the invention, the base dental policy may provide for policy participants to receive the gum treatments/periodontic benefits at no cost, substantially no cost or at a fixed or defined benefit amount, and such benefits may be limited based on a time period (e.g., once per year, twice per year, etc.)

Dentures and other prosthetic benefits include complete, immediate and partial dentures, denture maintenance, surgical implants and implant maintenance, pontics, retainers, denture inlays and onlays, denture crowns, posts and cores. The benefit payments may be made, for example, directly to the policy participant or to a service provider. In embodiments of the invention, the base dental policy may provide for policy participants to receive the dentures and other prosthetic benefits at no cost, substantially no cost or at a fixed or defined benefit amount, and such benefits may be limited based on a time period (e.g., once per year, twice per year, etc.)

Repairs and adjustments to prosthetic benefits include adjustments, replacements, rebasing and relining complete, immediate and partial dentures, tissue conditioning, and repair or removal of implants. The benefit payments may be made, for example, directly to the policy participant or to a service provider. In embodiments of the invention, the base dental policy may provide for policy participants to receive the repairs and adjustments to prosthetic benefits at no cost, substantially no cost or at a fixed or defined benefit amount, and such benefits may be limited based on a time period (e.g., once per year, twice per year, etc.)

Extractions and other oral surgery benefits include coronal remnants; extractions of an erupted tooth or exposed root; removal of impacted teeth; surgical removal of teeth or roots; biopsies of oral tissue; alveoloplasty; vestibuloplasty; excision of lesions, cysts or tumors (benign or malignant); removal of lateral exostosis, torus palatinus, torus mandibularis; surgical reduction of osseus tuberosity; incision and drainage of abscesses; removal of foreign bodies, tooth fragments, or nonvital bone; open or closed reductions of the maxilla, mandible and/or zygomatic arch, malar, and alveolus; frenulectomy; and excision of hyperplastic tissue or pericoronal gingival. The benefit payments may be made, for example, directly to the policy participant or to a service provider. In embodiments of the invention, the base dental policy may provide for policy participants to receive the extractions and other oral surgery benefits at no cost, substantially no cost or at a fixed or defined benefit amount, and such benefits may be limited based on a time period (e.g., once per year, twice per year, etc.)

Pain relief and adjunctive services benefits include palliative treatments; deep sedation/general anesthesia; analgesia, anxiolysis, nitrous oxide; intravaneous sedation/analgesia; consultation; housed/extended care facility/hospital call; office visit; and case presentation and treatment planning. The benefit payments may be made, for example, directly to the policy participant or to a service provider. In embodiments of the invention, the base dental policy may provide for policy participants to receive the pain relief and adjunctive services benefits at no cost, substantially no cost or at a fixed or defined benefit amount, and such benefits may be limited based on a time period (e.g., once per year, twice per year, etc.)

Cosmetic Dental Insurance Benefits

While generally offered in addition to base benefits (i.e., a “rider”), cosmetic dental insurance benefits may also be offered as a stand-alone policy or in conjunction with a base or other types of dental insurance policies. Generally, “cosmetic” as used herein describes services provided to improve the patient's physical appearance, from which no significant improvement in physiologic function can be expected, regardless of emotional or psychological factors. A “rider” as used herein refers to an amendment to an insurance policy that becomes a part of the insurance contract and expands or limits the benefits payable. A rider may also be referred to as an endorsement. Exemplary riders for a base dental insurance policy include an orthodontic benefit rider and or a cosmetic benefit rider. The cost or premium of the base dental insurance policy is generally adjusted in accordance with the number or type of riders that are provided in addition to the base policy.

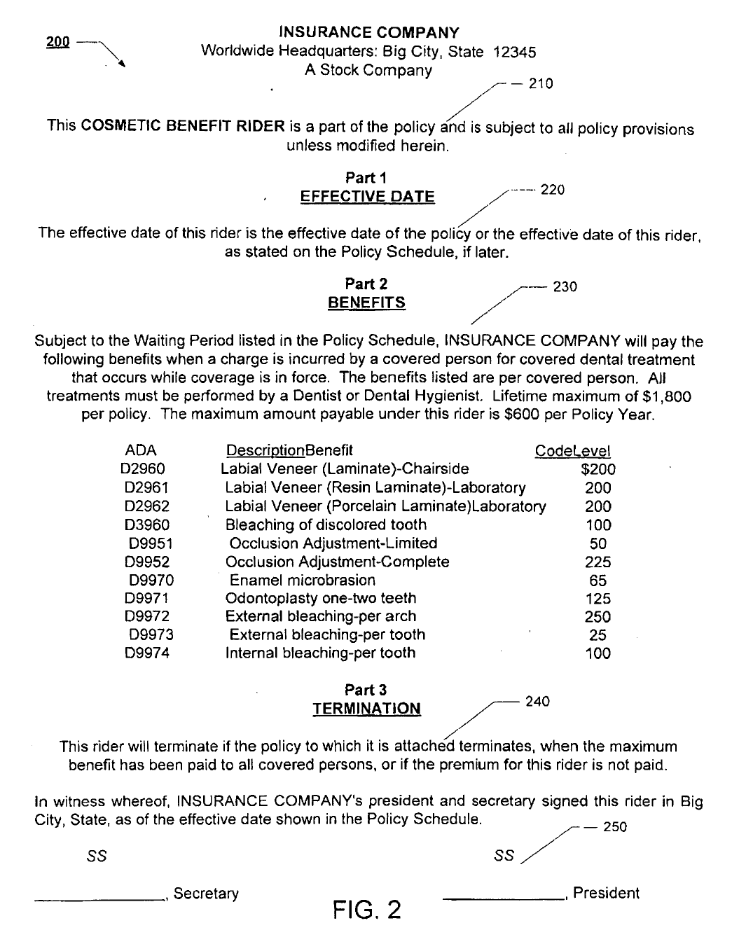

An exemplary cosmetic benefits rider is shown in FIG. 2. As shown, the cosmetic benefits rider 200 of FIG. 2 is comprised of a preamble 210, an effective date section 220, a benefits section 230, a termination section 240, and a signature/authorization section 250.

The preamble 210 introduces the rider 200. The effective date 220 informs the policyholder of when the policy goes into effect. The benefits section 230 describes the benefits provided under the rider 200 and some limitations on those benefits. The termination section 240 informs the policyholder of when the rider 200 ends. The signature/authorization section 250 indicates the insurer's acceptance of the rider 200.

Below, the benefits section 230 of the exemplary cosmetic benefit rider 200 of FIG. 2 is reproduced as Table III. It is to be noted that the benefits shown in Table III, and FIG. 2, are exemplary in nature and it is to be appreciated that the embodiments of this invention include a cosmetic benefit rider that may have more, fewer, and/or different benefits than those illustrated in Table III and FIG. 2

TABLE III
COSMETIC BENEFITS

| ADA | | Benefit |
|---|---|---|
| Code | Description | Level |
| D2960 | Labial Veneer (Laminate)—Chairside | $200 |
| D2961 | Labial Veneer (Resin Laminate)—Laboratory | 200 |
| D2962 | Labial Veneer (Porcelain Laminate)Laboratory | 200 |
| D3960 | Bleaching of discolored tooth | 100 |
| D9951 | Occlusion Adjustment—Limited | 50 |
| D9952 | Occlusion Adjustment—Complete | 225 |
| D9970 | Enamel microbrasion | 65 |
| D9971 | Odontoplasty one-two teeth | 125 |
| D9972 | External bleaching—per arch | 250 |
| D9973 | External bleaching—per tooth | 25 |
| D9974 | Internal bleaching—per tooth | 100 |

A typical cosmetic benefit provides for one or more benefit payments to be made in response to a policy participant having a covered treatment performed, as such covered treatments are defined by the schedule of benefits (e.g., Table III), while coverage is in force. In Table III (and FIG. 2), the benefits listed are per covered person. Generally, the treatments must be performed by a dentist or a dental hygienist. A “dentist” may be defined for a base dental policy and the rider as a legally qualified person who is licensed by the state to treat the type of condition for which a claim is made. And, a “dental hygienist” may be defined as a legally qualified person who is licensed by the state to treat the type of condition for which a claim is made. In some instances, members of a covered party's immediate family are excluded from the definition of a dentist or a dental hygienist.

In Table III, and FIG. 2, each benefit is associated with an American Dental Association (ADA) code to facilitate standardized description of the treatment and billing. It is to be noted that this invention can be practiced without the ADA code. Furthermore, it is to be noted that each benefit is associated with a benefit level, which is the payment made in response to a policy participant having a covered treatment performed.

Benefits may be limited to a lifetime maximum and/or an annual or “policy year” maximum. For instance, the benefits section 230 of FIG. 2 indicates that for the exemplary benefits shown, the lifetime maximum is $1,800 per policy and the maximum amount payable under the rider 200 is $600 per policy year.

As shown in Table III, exemplary cosmetic dental insurance benefits include (teeth) veneers, such as labial veneers, that are comprised of laminates, resin laminates, porcelain laminates, or combinations thereof. The benefit payments may be made, for example, directly to the policy participant or to a service provider. In embodiments of the invention, the cosmetic dental policy may provide for policy participants to receive the veneer benefits at no cost, substantially no cost or at a fixed or defined benefit amount, and such benefits may be limited based on a time period (e.g., once per year, twice per year, etc.) Other cosmetic benefits include occlusion adjustments, enamel microbrasions, odontoplasty, and bleaching of the teeth. As above, benefit payments may be made, for example, directly to the policy participant or to a service provider. In embodiments of the invention, the cosmetic dental policy may provide for policy participants to receive the benefits at no cost, substantially no cost or at a fixed or defined benefit amount, and such benefits may be limited based on a time period (e.g., once per year, twice per year, etc.)

Issuing Policy

System Architecture

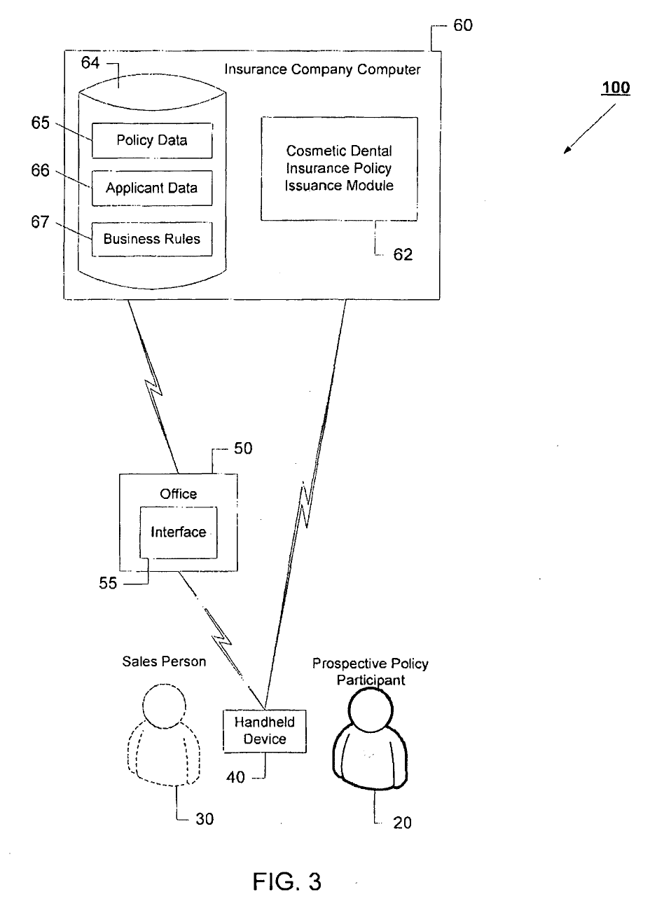

FIG. 3 shows a block diagram of a system for issuing a cosmetic dental policy 100 in accordance with various embodiments of the present invention. As may be understood from this figure, the system 100 may include a prospective policy participant 20 in contact with a salesperson 30 having a computing device 40, into which the salesperson 30 can enter Applicant data received from the prospective policy participant 20. As can be appreciated by one of ordinary skill in the art, the computing device 40 may be any type of computing device, including, for example, a mobile telephone, personal data assistant (PDA), laptop or mobile personal computer (PC), desktop unit, or workstation.

The system further includes an office 50 in communication with the handheld device 40, and an Insurance Company computer 60 in communication with the office 50. The office 50, which may be operated directly by the Insurance Company or by some other entity affiliated with the Insurance Company, includes at least an interface 55 to facilitate the communication of Applicant data between the handheld device 40 and the Insurance Company computer 60. The interface 55 may be any known interface including, for example, a docking station that is connected to an IT infrastructure, such as a Local Area Network (LAN), Wide Area Network (WAN), or the Internet. Data can, therefore, be communicated from the office 50 to the Insurance Company computer 60 via any known means of communicating data including, for example, via the Internet, via a cable connection, by fax, via a telephone network, or even by a human operator located at the office 50.

Alternatively, the computing device 40 can be configured to communicate with the insurance company computer 60 directly without the need for office 50 and the interface 55. The computing device 40 can communicate with the Insurance Company computer 60 via a communications network such as the Internet, WAN, one or more LANs, wireless network, cellular network, etc.

The Insurance Company computer 60 includes at least a cosmetic dental insurance policy issuance module 62. The module 62 can be configured to retrieve data from, and store data to, a database 64. As shown, policy data 65, Applicant data 66 and business rules 67 can each be stored in the database 64 and accessed by the cosmetic dental insurance policy issuance module 62.

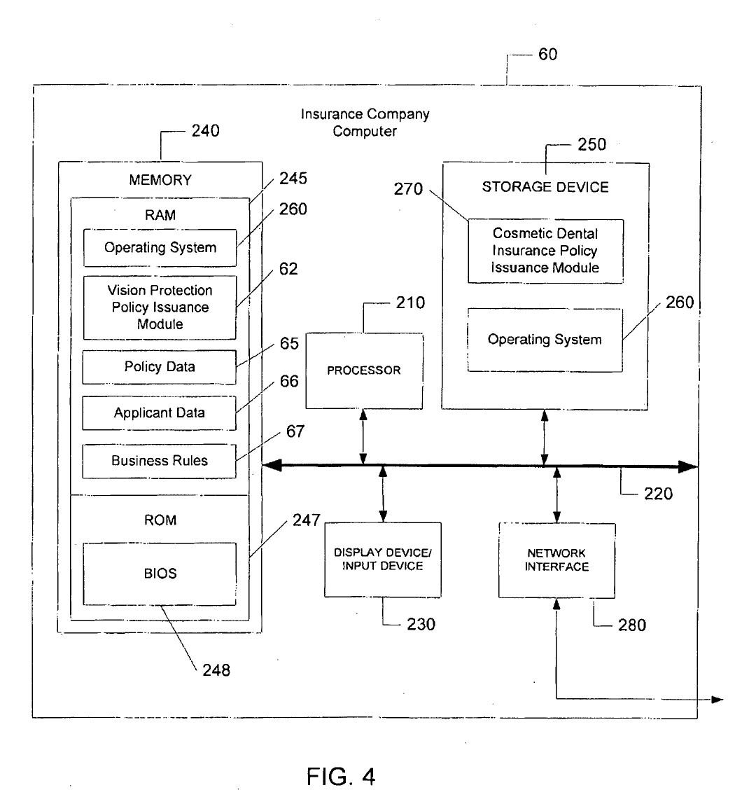

FIG. 4 shows an exemplary schematic diagram of the Insurance Company computer 60 according to one embodiment of the invention. The Insurance Company computer 60 includes a processor 210 that communicates with other elements within the Insurance Company computer 60 via a system interface or bus 220. The processor 210 could be, for example, a central processing unit, microprocessor, microcontroller, programmable gate array, or some other device that processes data. Also included in the Insurance Company computer 60 is a display device/input device 230 for receiving and displaying data. The unit 230 may include, for example, an input device such as a keyboard, mouse or pointing device, and a display device such as a monitor, cathode ray tube (CRT), liquid crystal display (LCD), or other such device. The Insurance Company computer 60 further includes a memory 240, which includes both random access memory (RAM) 245 and read only memory (ROM) 247. The computer's ROM 247 is used to store a basic input/output system 248 (BIOS), containing the basic routines that help to transfer information between elements within the Insurance Company computer 60. The computer's RAM 245 is used to store the policy data 65, Applicant data 66 and business rules 67.

In addition, the Insurance Company computer 60 includes at least one storage device 250, such as a hard disk drive, a floppy disk drive, a CD-ROM drive, or optical disk drive, for storing information on various computer-readable media, such as a hard disk, a removable magnetic disk, or a CD-ROM disk. As will be appreciated by one of ordinary skill in the art, each of these storage devices 250 is connected to the system bus 220 by an appropriate interface. The storage devices 250 and their associated computer-readable media provide nonvolatile storage for a personal computer. It is important to note that the computer-readable media described above could be replaced by any other type of computer-readable media known in the art. Such media include, for example, magnetic cassettes, flash memory cards, digital video disks, and Bernoulli cartridges.

A number of program modules may be stored by the various storage devices 250 and within RAM 245. Such program modules include an operating system 260, and the cosmetic dental insurance policy issuance module 270. The cosmetic dental insurance issuance module 270 controls certain aspects of the operation of the Insurance Company computer 60, as is described in more detail below, with the assistance of the processor 210 and the operating system 260.

Also located within the Insurance Company computer 60 is a network interface 280, for interfacing and communicating with other elements of a computer network. It will be appreciated by one of ordinary skill in the art that one or more of the Insurance Company computer 60 components may be located geographically remotely from other Insurance Company computer 60 components. Furthermore, one or more of the components may be combined, and additional components performing functions described herein may be included in the Insurance Company computer 60.

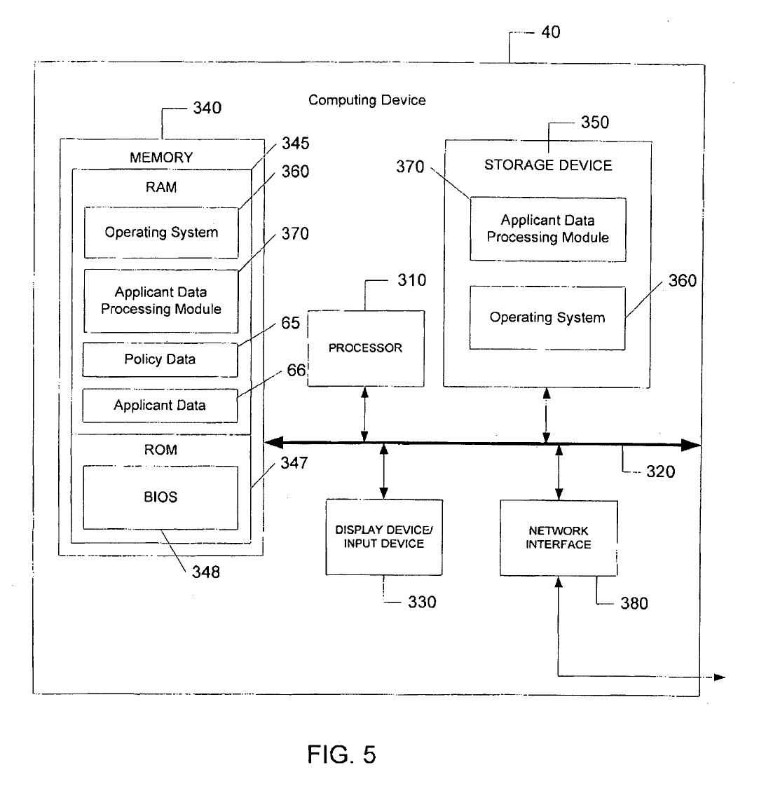

FIG. 5 shows an exemplary schematic diagram of the Computing Device 40 according to one embodiment of the invention. The Computing Device 40 is used by the prospective policy participant 20 or the salesperson 30, or both, to receive Applicant data 66 and to transfer the same to the Insurance Company computer 60. The elements of the Computing Device 40 shown in FIG. 5 are the same or similar to corresponding elements of the Insurance Company computer 60 shown in FIG. 4, with a few exceptions. In particular, the Computing Device 40 includes a processor 310 that communicates with other elements within the Computing Device 40 via a system interface or bus 320, a display device/input device 330 for receiving and displaying data, a memory 340, which includes both random access memory (RAM) 345 and read only memory (ROM) 347, wherein the ROM 347 is used to store a basic input/output system 348 (BIOS) and the RAM 345 is used to at least temporarily store policy data 65 and applicant data 66, at least one storage device 350, and a network interface 380, for interfacing and communicating with other elements of a computer network.

Like the Insurance Company computer 60, a number of program modules may be stored by the various storage devices 350 and within RAM 345. Such program modules include an operating system 360, and an applicant data processing module 370. The applicant data processing module 370 controls certain aspects of the operation of the Computing Device 40, as is described in more detail below, with the assistance of the processor 310 and the operating system 360.

Method of Issuing Cosmetic Dental Insurance Policy

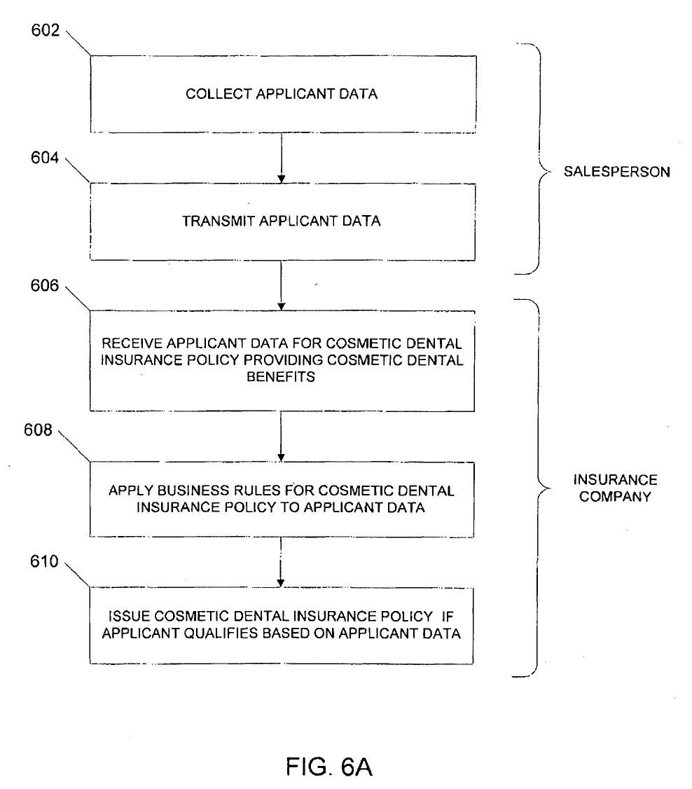

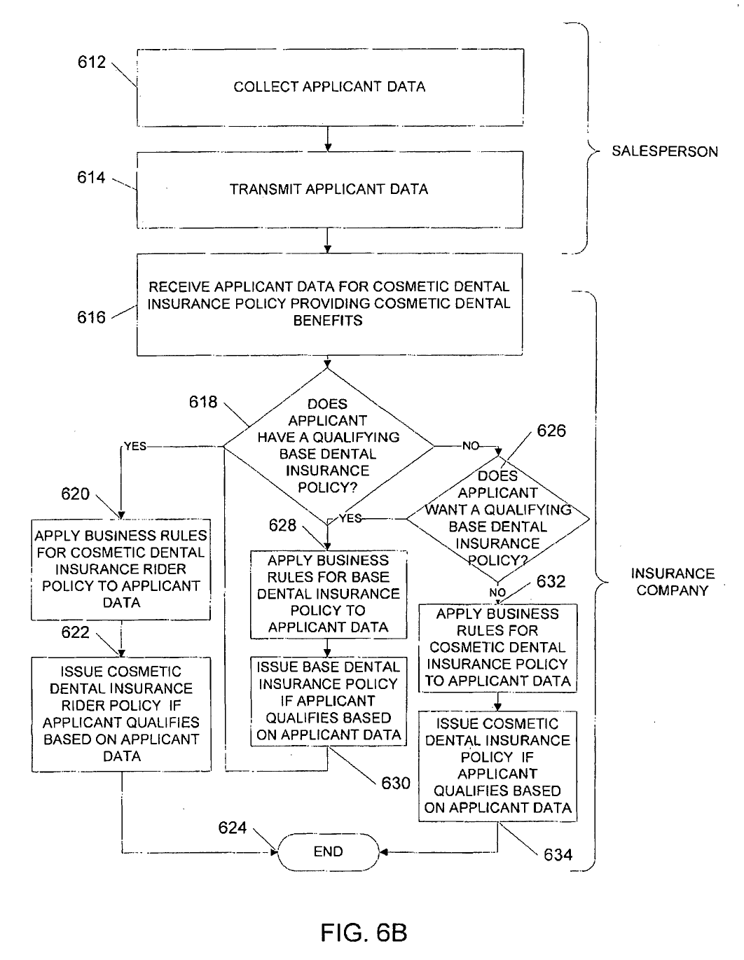

FIG. 6A illustrates the steps taken when issuing the above described cosmetic dental insurance policy according to one embodiment of the present invention. As shown, in one embodiment the process of issuing a cosmetic dental insurance policy begins at Step 602 in which a salesperson collects Applicant data 66 from a prospective policy participant and enters it into his or her computing device 40. In Step 604, the salesperson transmits the Applicant data 66 from the computing device 40 to the Insurance Company computer 60 using the application data processing module 370 on the computing device 40. The Applicant data collected may include, for example, the prospective policy participant's name, address or medical history, and/or other types of insurance coverage owned by the prospective policy participant.

In other embodiments, the process could likewise begin with a prospective policy participant entering his or her own Applicant data directly into an application form provided by the Insurance Company, and sending the application form to the Insurance Company. The application form could be in hard copy, requiring, for example, that the prospective policy participant enter the Applicant data by hand, and then mail or fax the form to the Insurance Company. The Applicant data could then be entered into the Insurance Company computer 60 by, for example, an Insurance Company employee. Alternatively, the application form could be provided over the Internet on a website operated by the Insurance Company, or by some other company affiliated with the Insurance Company. In this case the prospective policy participant could merely enter the data into the online version of the application form and then send the data electronically to the Insurance Company computer 60. In yet another embodiment, the prospective policy participant may contact an Insurance Company operator directly, by telephone or by other means, and communicate the Applicant data to the operator, the data is then into the Insurance Company computer 60 by the operator or another associated individual.

Once the Insurance Company computer 60 has received the Applicant data 66, in Step 606, the Insurance Company computer 60 stores the Applicant data 66 in a database 64 on the Insurance Company computer 60. The cosmetic dental insurance policy issuance module 62 then applies business rules 67, which are also stored in the database 64 on the Insurance Company computer 60, to the Applicant data 66 to determine whether the prospective policy participant qualifies for the cosmetic dental insurance policy (Step 608). This may include, for example, checking the applicant's name and address to determine whether they are valid, authenticating the applicant to ensure that the applicant is who he/she claims to be, determining whether the applicant is financially responsible based on a credit or payment history check, for example, determining whether the applicant's medical/dental history and status are within risk parameters of the policy, determining whether the applicant has pre-existing conditions that should be excluded from policy coverage, determining whether the applicant is of legal age to enter a binding contract in the State in which a policy is sought, etc. Furthermore, if the cosmetic dental insurance policy is a rider to a base dental insurance policy, business rules may be invoked to determine whether the applicant's base policy is in effect and whether there are any outstanding premiums or other issues that may affect coverage.

If the Insurance Company computer 60 determines that the applicant is not qualified for the policy based on the applicant data 66 and business rules 67, then the Insurance Company computer 60 rejects the application. Conversely, upon a determination by the Insurance Company computer 60 that the prospective policy participant qualifies for the cosmetic dental insurance policy, in Step 610 the Insurance Company issues the cosmetic dental insurance policy to the policy participant by, for example, generating policy data 65 that is specific to the prospective policy participant, storing the policy data 65 in the database 64, and transmitting the policy data 65 to the policy participant. The policy data 65 may be sent, for example, electronically, by mail, by fax or delivered by hand, to the policy participant directly, or via the salesperson.

FIG. 6B illustrates the steps taken when issuing a cosmetic dental insurance policy or a cosmetic dental rider to a base dental insurance policy according to one embodiment of the present invention. As shown, in the embodiment of FIG. 6B, the process of issuing a cosmetic dental insurance policy begins at Step 612 in which a salesperson collects Applicant data 66 from a prospective policy participant and enters it into his or her computing device 40. In Step 614, the salesperson transmits the Applicant data 66 from the computing device 40 to the Insurance Company computer 60 using the application data processing module 370 on the computing device 40. The Applicant data collected may include, for example, the prospective policy participant's name, address or medical history, and/or other types of insurance coverage owned by the prospective policy participant.

In other embodiments, the process likewise begins with a prospective policy participant entering his or her own Applicant data directly into an application form provided by the Insurance Company, and sending the application form to the Insurance Company. The application form could be in hard copy, requiring, for example, that the prospective policy participant enter the Applicant data by hand, and then mail or fax the form to the Insurance Company. The Applicant data could then be entered into the Insurance Company computer 60 by, for example, an Insurance Company employee. Alternatively, the application form could be provided over the Internet on a website operated by the Insurance Company, or by some other company affiliated with the Insurance Company. In this case the prospective policy participant could merely enter the data into the online version of the application form and then send the data electronically to the Insurance Company computer 60. In yet another embodiment, the prospective policy participant may contact an Insurance Company operator directly, by telephone or by other means, and communicate the Applicant data to the operator, the data is then entered into the Insurance Company computer 60 by the operator or another associated individual.

Once the Insurance Company computer 60 has received the Applicant data 66, in Step 616, the Insurance Company computer 60 stores the Applicant data 66 in a database 64 on the Insurance Company computer 60. At Step 618, from the Applicant data 66, the cosmetic dental insurance policy issuance module determines whether the applicant has a qualified base dental insurance policy. “Qualified,” in this sense, means a base dental insurance policy for which the issuer is willing to issue a cosmetic dental insurance rider policy (see FIG. 2). If the applicant does have a qualified base dental insurance policy, then the process goes to Step 620. The cosmetic dental insurance policy issuance module 62 then applies business rules 67, which are also stored in the database 64 on the Insurance Company computer 60, to the Applicant data 66 to determine whether the prospective policy participant qualifies for the cosmetic dental insurance rider policy (Step 620). This may include, for example, checking the applicant's name and address to determine whether they are valid, authenticating the applicant to ensure that the applicant is who he/she claims to be, determining whether the applicant is financially responsible based on a credit or payment history check, for example, determining whether the applicant's medical/dental history and status are within risk parameters of the policy, determining whether the applicant has pre-existing conditions that should be excluded from policy coverage, determining whether the applicant is of legal age to enter a binding contract in the State in which a policy is sought, etc. Business rules may be invoked to determine whether the applicant's base policy is in effect and whether there are any outstanding premiums or other issues that may affect coverage.

If the Insurance Company computer 60 determines that the applicant is not qualified for the rider policy based on the applicant data 66 and business rules 67, then the Insurance Company computer 60 rejects the application. Conversely, upon a determination by the Insurance Company computer 60 that the prospective policy participant qualifies for the cosmetic dental insurance rider policy, in Step 622 the Insurance Company issues the cosmetic dental insurance rider policy to the policy participant by, for example, generating policy data 65 that is specific to the prospective policy participant, storing the policy data 65 in the database 64, and transmitting the policy data 65 to the policy participant. The policy data 65 may be sent, for example, electronically, by mail, by fax or delivered by hand, to the policy participant directly, or via the salesperson. The process then ends at Step 624.

If, at Step 618, the applicant does not have a qualified base dental insurance policy, then the process goes to Step 626. At Step 626 it is determined whether the applicant wants to apply for a qualifying base dental insurance policy. If so, then the process goes to Step 628. At Step 628, the cosmetic dental insurance policy issuance module 62 applies business rules 67, which are also stored in the database 64 on the Insurance Company computer 60, to the Applicant data 66 to determine whether the prospective policy participant qualifies for a qualified base dental insurance policy. This may include, for example, checking the applicant's name and address to determine whether they are valid, authenticating the applicant to ensure that the applicant is who he/she claims to be, determining whether the applicant is financially responsible based on a credit or payment history check, for example, determining whether the applicant's medical/dental history and status are within risk parameters of the policy, determining whether the applicant has pre-existing conditions that should be excluded from policy coverage, determining whether the applicant is of legal age to enter a binding contract in the State in which a policy is sought, etc.

If the Insurance Company computer 60 determines that the applicant is not qualified for the base policy based on the applicant data 66 and business rules 67, then the Insurance Company computer 60 rejects the application. Conversely, upon a determination by the Insurance Company computer 60 that the prospective policy participant qualifies for the base dental insurance policy, in Step 630 the Insurance Company issues the base dental insurance policy to the policy participant by, for example, generating policy data 65 that is specific to the prospective policy participant, storing the policy data 65 in the database 64, and transmitting the policy data 65 to the policy participant. The policy data 65 may be sent, for example, electronically, by mail, by fax or delivered by hand, to the policy participant directly, or via the salesperson. The process then goes to Steps 620 and 630, where the applicant is issued a cosmetic dental insurance rider policy, as described above. The process then ends at Step 624.

If, at Step 626, it is determined that the applicant does not want to apply for a qualifying base dental insurance policy then, in one embodiment of the invention, the applicant may be issued a stand-alone cosmetic dental insurance policy beginning at Step 632. At Step 632, the cosmetic dental insurance policy issuance module 62 applies business rules 67, which are also stored in the database 64 on the Insurance Company computer 60, to the Applicant data 66 to determine whether the prospective policy participant qualifies for a cosmetic dental insurance policy. This may include, for example, checking the applicant's name and address to determine whether they are valid, authenticating the applicant to ensure that the applicant is who he/she claims to be, determining whether the applicant is financially responsible based on a credit or payment history check, for example, determining whether the applicant's medical/dental history and status are within risk parameters of the policy, determining whether the applicant has pre-existing conditions that should be excluded from policy coverage, determining whether the applicant is of legal age to enter a binding contract in the State in which a policy is sought, etc.

If the Insurance Company computer 60 determines that the applicant is not qualified for the stand-alone policy based on the applicant data 66 and business rules 67, then the Insurance Company computer 60 rejects the application. Conversely, upon a determination by the Insurance Company computer 60 that the prospective policy participant qualifies for the cosmetic dental insurance policy, in Step 634 the Insurance Company issues the cosmetic dental insurance policy to the policy participant by, for example, generating policy data 65 that is specific to the prospective policy participant, storing the policy data 65 in the database 64, and transmitting the policy data 65 to the policy participant. The policy data 65 may be sent, for example, electronically, by mail, by fax or delivered by hand, to the policy participant directly, or via the salesperson. The process then goes to Steps 620 and 630, where the applicant is issued a cosmetic dental insurance rider policy, as described above. The process then ends at Step 624.

Claim Processing

System Architecture

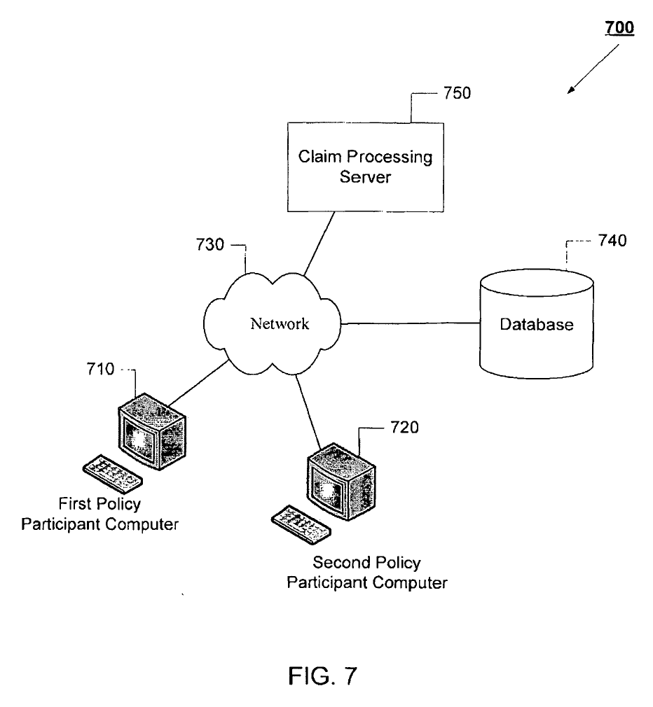

FIG. 7 shows a block diagram of a system 700 for processing a cosmetic dental insurance policy claim in accordance with various embodiments of the present invention. As may be understood from this figure, the system 700 may include one or more policy participant computers 710, 720 that are connected, via a network 730 (e.g., a Local Area Network (LAN), wide area network (WAN), Internet, etc.), to a Claim Processing Server 750. In one embodiment, the Claim Processing Server 750 is configured to retrieve data from, and store data to, a database 740 that may be stored on (or, alternatively, stored remotely from) the Claim Processing Server 750.

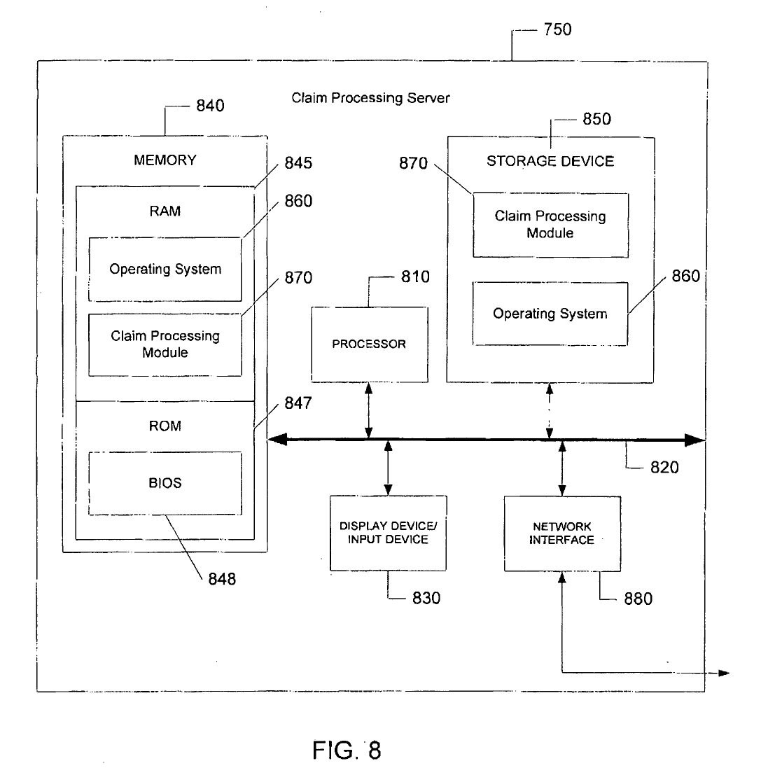

FIG. 8 shows a schematic diagram of the Claim Processing Server 750 according to one embodiment of the invention. The elements of the Claim Processing Server 750 shown in FIG. 8 are the same or similar to corresponding elements of the Insurance Company computer 60 shown in FIG. 4 and of the Computing Device 40 shown in FIG. 5, with a few exceptions. In particular, the Claim Processing Server 750 includes a processor 810 that communicates with other elements within the Claim Processing Server 750 via a system interface or bus 820, a display device/input device 830 for receiving and displaying data, a memory 840, which includes both random access memory (RAM) 845 and read only memory (ROM) 847, wherein the ROM 847 is used to store a basic input/output system 848 (BIOS), at least one storage device 850, and a network interface 880, for interfacing and communicating with other elements of a computer network.

Like the Insurance Company computer 60 and the Computing Device 40, a number of program modules may be stored by the various storage devices 850 and within RAM 845. Such program modules include an operating system 860, and a claim processing module 870. The claim processing module 870 controls certain aspects of the operation of the Claim Processing Server 750, as is described in more detail below, with the assistance of the processor 810 and the operating system 860.

Method of Processing Cosmetic Dental Insurance Policy Claim

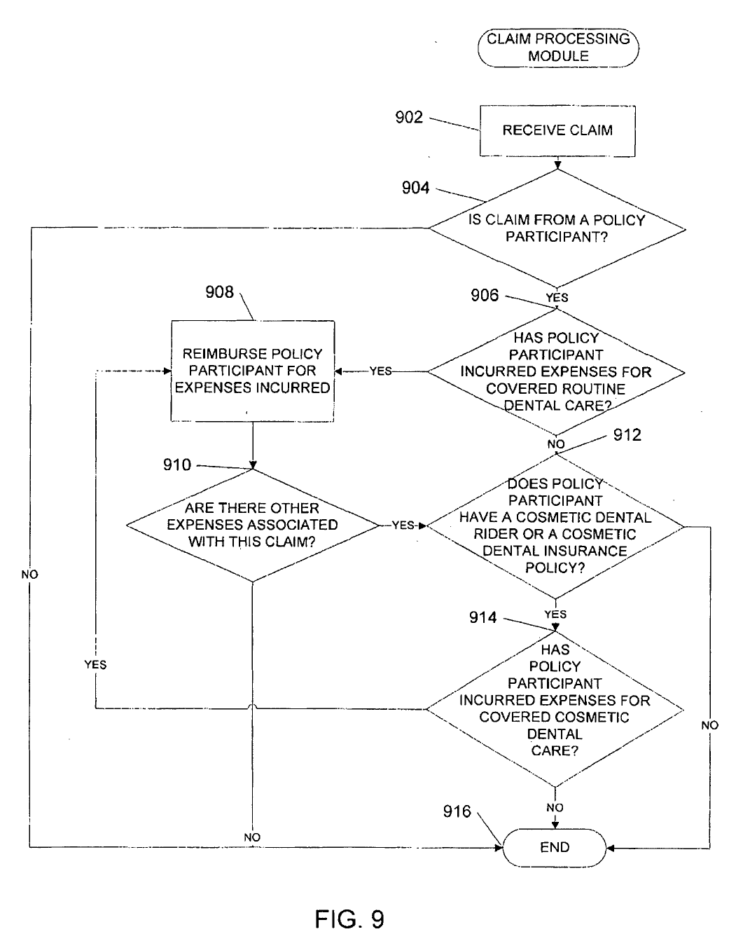

FIG. 9 depicts a process of the Claim Processing Module 870 according to one embodiment of the invention. In general, this figure illustrates the steps taken when processing a claim received from a cosmetic dental insurance policy participant according to various embodiments of the present invention. As may be understood from this figure, the process begins at Step 902 in which the Claim Processing Module 870 on the Claim Processing Server 750 receives a dental insurance policy claim. As will be understood by those of skill in the art, the claim may have been communicated by the policy participant, for example, by telephone, mail, fax, or network (e.g., the Internet) by electronic, optical, or wireless media, for example. Once received, the Claim Processing Module 870, in one embodiment, first determines, based on the claim received, whether the claim is received from a Policy Participant at Step 904. If it is determined at Step 904 that the claim is from a Policy Participant, then at Step 906 it is determined whether the Policy Participant has incurred an expense for a routine dental procedure, which may include, for example, expenses associated with procedures described in Tables I and II, above. The Policy Participant may prove that it has incurred the expense by submitting, along with the claim for reimbursement, an invoice or statement of services rendered by the dentist, dental hygienist, or other qualified dentistry service provider. In other embodiments, the Insurance Company can receive and store in a database accessible to the Claim Processing Module 870 data that reflects expenses incurred by policy participants directly from cosmetic dental care service providers. By using the claim information, the Claim Processing Module 870 can check the database to determine whether the expense for the service was incurred by the Policy Participant. If, at Step 904 it is determined that the claim is not received from a policy participant, then the process goes to Step 916 where it ends.

If, at Step 906, it is found that the Policy Participant has in fact incurred one of the routine dental procedure expenses (e.g., Tables I and II, above) covered by the base dental insurance policy, the Claim Processing Module 870, in one embodiment, determines that the Insurance Company is to provide, in Step 908, at least partial reimbursement to the policy participant for the expenses incurred. The amount of reimbursement and the extent that these expenses are covered varies for different embodiments of the present invention. For example, in one embodiment, if the policy participant has only a base dental insurance policy, then the policy participant is not reimbursed for any expenses incurred when undergoing a cosmetic procedure; while in other embodiments, if the policy participant has a cosmetic dental rider or a cosmetic dental insurance policy, the participant may receive partial or full reimbursement for such expenses, as further described herein. If, at Step 906, it is determined that the policy participant incurred expenses for other than covered routine dental care, then the process goes to Step 912, further described below.

After payment (or partial payment) of the expenses at Step 908, the process goes to Step 910. At Step 910, the Claim Processing Module 870 determines whether there are any other expenses associated with the claim that were not for routine dental care. If, at Step 910, there are no additional expenses associated with the claim, then the process of the Claims Processing Module 870 goes to Step 916, at which the process ends. If, at Step 910, there are additional expenses with the claim, then the process goes to Step 912 where it is determined whether the policy participant participates in a cosmetic dental insurance policy or a cosmetic dental rider.

If, at Step 912, the policy participant does participate in a cosmetic dental insurance policy, then the process goes to Step 914. If, at Step 912, it is determined that the policy participant does not participate in a cosmetic dental insurance policy, then the process goes to Step 916, at which it ends.

At Step 914 it is determined whether the policy participant has received a procedure for which coverage is provided by the cosmetic dental insurance policy. Exemplary procedures that are covered by the cosmetic dental insurance policy may include, for example, those procedures listed in Table III. If the policy participant has received one or more of the covered procedures, the Claim Processing Module 870 determines that the Insurance Company is to make, in Step 908, one or more cosmetic dental insurance benefit payments to the policy participant. In one embodiment, the one or more cosmetic dental insurance benefit payments include a payment of a pre-defined amount (e.g., $1000).

If it is determined that the policy participant has not incurred expenses for routine dental care or cosmetic dental care, the claim received is not valid and a denial letter is generated, after which the process ends (shown in Step 916).

As will be understood by those of ordinary skill in the art, the steps of process described above need not be performed in the order in which they are described above. For instance, it is not necessary that the Claim Processing Module 870 determine whether the policy participant has received routine dental care before determining whether the policy participant has received cosmetic dental procedures, as long as the necessary determinations are made to assess what benefits the policy participant should receive.

Modifications and Alternative Embodiments

Many modifications and other embodiments of the invention will come to mind to one skilled in the art to which this invention pertains having the benefit of the teachings presented in the foregoing descriptions. Accordingly, it should be understood that the invention is not to be limited to the specific embodiments disclosed and that modifications and other embodiments are intended to be included within the scope of the appended exemplary inventive concepts. Although specific terms are employed herein, they are used in a generic and descriptive sense only and not for purposes of limitation.

That which is claimed:

1. A system for issuing a cosmetic dental insurance policy, said system comprising:
a processor; and
a memory coupled to said processor and storing an application that the processor executes to:
receive applicant data related to a prospective policy participant;
apply one or more business rules stored in said memory to said applicant data to determine whether said prospective policy participant qualifies for said cosmetic dental insurance policy; and
transmit said cosmetic dental insurance policy to a policy participant, wherein said policy participant is comprised of said prospective policy participant determined to qualify for said cosmetic dental insurance policy,
wherein said cosmetic dental insurance policy provides a cosmetic dental benefit that provides a payment to a provider or the policy participant of a portion or all of a covered cosmetic dental procedure.

2. The system of claim 1, wherein said cosmetic dental insurance policy comprises a rider to a base dental insurance policy.

3. The system of claim 2, wherein said covered cosmetic dental procedures comprise one or more of labial veneers, bleaching of discolored teeth, occlusion adjustment, odontoplasty, or enamel microbrasion.

4. The system of claim 1, wherein said cosmetic dental benefits comprises payment of a pre-defined amount to be made to said policy participant or to said provider.

5. The system of claim 4, wherein said provider comprises a dentist or a dental hygienist.

6. A system for processing a cosmetic dental insurance policy claim, said system comprising:
a processor; and
a memory connected to said processor and storing a computer program executed by said processor to:
(a) receive a cosmetic dental insurance policy claim from a policy participant, wherein said policy participant is a policyholder of a cosmetic dental insurance policy;
(b) determine whether said policy participant incurred one or more expenses relating to covered cosmetic dental procedures; and
(c) authorize provision of a cosmetic dental benefit based on the determination made in step (b), above.

7. The system of claim 6, wherein said covered cosmetic dental procedures comprise one or more of labial veneers, bleaching of discolored teeth, occlusion adjustment, odontoplasty, or enamel microbrasion.

8. The system of claim 6, wherein said cosmetic dental benefit comprises payment of a pre-defined amount to be made to said policy participant or to a provider.

9. The system of claim 8, wherein said provider comprises a dentist or a dental hygienist.

10. The system of claim 6, wherein said cosmetic dental insurance policy comprises a rider to a base dental insurance policy.

11. A cosmetic dental insurance policy providing:
a cosmetic dental benefit that provides for one or more cosmetic dental benefit payments to be made in response to a policy participant receiving covered cosmetic dental procedures from a provider.

12. The cosmetic dental insurance policy of claim 11, wherein said covered cosmetic dental procedures comprise one or more of labial veneers, bleaching of discolored teeth, occlusion adjustment, odontoplasty, or enamel microbrasion.

13. The cosmetic dental insurance policy of claim 11, wherein said cosmetic dental benefit comprises payment of a pre-defined amount to be made to said policy participant or to said provider.

14. The cosmetic dental insurance policy of claim 13, wherein said provider comprises a dentist or a dental hygienist.

15. The cosmetic dental insurance policy of claim 11, wherein said cosmetic dental insurance policy comprises a rider to a base dental insurance policy.

16. A method of issuing a cosmetic dental insurance policy, said method comprising the steps of:
receiving applicant data related to a prospective policy participant;
determining, based at least in part on said applicant data, whether said prospective policy participant qualifies for said cosmetic dental insurance policy; and
issuing said cosmetic dental insurance policy to a policy participant, wherein said policy participant is comprised of said prospective policy participant determined to qualify for said cosmetic dental insurance policy,
wherein said cosmetic dental insurance policy provides a cosmetic dental benefit that provides a payment to a provider or the policy participant of a portion or all of a covered cosmetic dental procedure.

17. The method of claim 16, wherein said covered cosmetic dental procedure comprises one or more or labial veneers, bleaching of discolored teeth, occlusion adjustment, odontoplasty, or enamel microbrasion.

18. The method of claim 16, wherein said cosmetic dental benefit comprises payment of a pre-defined amount to be made to said policy participant or to said provider.

19. The method of claim 18, wherein said provider comprises a dentist or a dental hygienist.

20. The method of claim 16, wherein said cosmetic dental insurance policy comprises a rider to a base dental insurance policy.

21. A method of processing a cosmetic dental insurance policy claim, said method comprising the steps of:
(a) receiving a cosmetic dental insurance policy claim from a policy participant;
(b) determining whether said policy participant incurred one or more expenses relating to a covered cosmetic dental procedure; and
(c) providing some cosmetic dental benefit based on the determination made in step (b), above.

22. The method of claim 21, wherein said covered cosmetic dental procedure comprises one or more of labial veneers, bleaching of discolored teeth, occlusion adjustment, odontoplasty, or enamel microbrasion.

23. The method of claim 21, wherein said cosmetic dental benefit comprises payment of a pre-defined amount to said policy participant or to a provider.

24. The method of claim 23, wherein said provider comprises a dentist or a dental hygienist.

25. The method of claim 21, wherein said cosmetic dental insurance policy comprises a rider to a base dental insurance policy.

26. A method of offering a cosmetic dental insurance policy, said method comprising the step of:
providing a cosmetic dental insurance application to an applicant, wherein the cosmetic dental insurance policy provides a cosmetic dental benefit comprised of a payment to a policy participant or a provider for covered cosmetic dental procedures;
receiving applicant information from said applicant;
determining whether said applicant is qualified to become one of the policy participants; and
if said applicant is authorized to become one of the policy participants; then issuing the cosmetic dental insurance policy to the applicant, said applicant thus becoming one of the policy participants.

27. The method of claim 26, wherein said covered cosmetic dental procedures comprises one or more of labial veneers, bleaching of discolored teeth, occlusion adjustment, odontoplasty, or enamel microbrasion.

28. The method of claim 26, wherein said cosmetic dental benefit comprises payment of a pre-defined amount to said policy participant or to a provider.

29. The method of claim 28, wherein said provider comprises a dentist or a dental hygienist.

30. The method of claim 26, wherein said cosmetic dental insurance policy comprises a rider to a base dental insurance policy.
